(19) United States
(12) Patent Application Publication
(10) Pub. No.: US 2025/0294381 A1
(43) Pub. Date: Sep. 18, 2025

(54) BEAM FAILURE RECOVERY FOR MULTIPLE TRANSMISSION AND RECEPTION POINTS

(71) Applicant: ZTE Corporation, Shenzhen (CN)

(72) Inventors: Wenfeng LIU, Shenzhen (CN); Bo GAO, Shenzhen (CN); Zhaohua LU, Shenzhen (CN); Ke YAO, Shenzhen (CN); Yang ZHANG, Shenzhen (CN)

(21) Appl. No.: 19/224,123

(22) Filed: May 30, 2025

Related U.S. Application Data
(63) Continuation of application No. PCT/CN2023/078160, filed on Feb. 24, 2023.

(51) Int. Cl. H04W 24/04; H04L 5/00; H04W 24/08

(52) U.S. Cl. CPC H04W 24/04; H04L 5/0053; H04W 24/08

(57) ABSTRACT

Methods, apparatus, and systems for beam failure recovery in scenarios with multiple transmission and reception points are disclosed. In one example aspect, a method of wireless communication comprises receiving, by a wireless device from a network node, a set of parameters. The wireless device determines, based on the set of parameters, a first reference signal (RS) set and a second RS set and performs a measurement of at least one RS of the first RS set. The wireless device determines a beam failure associated with the first RS set based on the measurement of the at least one RS of the first RS set. In some example aspects, the set of parameters indicates a first correspondence between the first RS set and a first control resource set (CORESET) and a second correspondence between the second RS set and a second CORESET.

### CROSS-REFERENCE TO RELATED APPLICATION

This application is a continuation and claims priority to International Application No. PCT/CN2023/078160, filed on Feb. 24, 2023, the disclosure of which is hereby incorporated by reference herein in its entirety.

### TECHNICAL FIELD

This document is directed generally to wireless communications.

### BACKGROUND

Wireless communication technologies are moving the world toward an increasingly connected and networked society. The rapid growth of wireless communications and advances in technology has led to greater demand for capacity and connectivity. Other aspects, such as energy consumption, device cost, spectral efficiency, and latency are also important to meeting the needs of various communication scenarios. In comparison with the existing wireless networks, next generation systems and wireless communication techniques need to provide support for an increased number of users and devices, as well as support an increasingly mobile society.

### SUMMARY

This document provides techniques for performing beam failure recovery (BFR) with multiple transmission and reception points.

In some exemplary aspects, the techniques described herein relate to a method of wireless communication. The method includes receiving, by a wireless device from a network node, a set of parameters; determining, by the wireless device based on the set of parameters, a first reference signal (RS) set and a second RS set; performing, by the wireless device, a measurement of at least one RS of the first RS set; and determining, by the wireless device, a beam failure associated with the first RS set at least based on the measurement of the at least one RS of the first RS set.

In some exemplary aspects, the techniques described herein relate to a method of wireless communication. The method includes: transmitting, to a wireless device from a network node, a set of parameters, wherein the set of parameters are configured to enable the wireless device to: determine, based on the set of parameters, a first reference signal (RS) set and a second RS set; and transmit, to the wireless device, at least one RS of the first RS set, causing the wireless device to: perform a measurement of the at least one RS of the first RS set; and determine a beam failure associated with the first RS set at least based on the measurement of the at least one RS of the first RS set.

In another exemplary aspect, the above-described methods are embodied in the form of processor-executable code and stored in a computer-readable program medium.

In yet another exemplary embodiment, a device that is configured or operable to perform the above-described methods is disclosed.

The above and other aspects and their implementations are described in greater detail in the drawings, the descriptions, and the claims.

### BRIEF DESCRIPTION OF THE DRAWINGS

FIG. 1 shows an example of a wireless communication system based on some example embodiments of the disclosed technology.

FIG. 2 illustrates an example process for beam failure recovery, in accordance with embodiments of the present disclosure.

FIG. 3 is a flow diagram illustrating an example process for wireless communication, in accordance with embodiments of the present disclosure.

FIG. 4 is a flow diagram illustrating an example process for wireless communication, in accordance with embodiments of the present disclosure.

FIG. 5 is a block diagram representation of a portion of an apparatus based on some embodiments of the disclosed technology.

### DETAILED DESCRIPTION

Section headings are used in the present document only for ease of understanding and do not limit scope of the embodiments to the section in which they are described. Furthermore, while embodiments are described with reference to 5G examples, the disclosed techniques may be applied to wireless systems that use protocols other than 5G or 3GPP protocols.

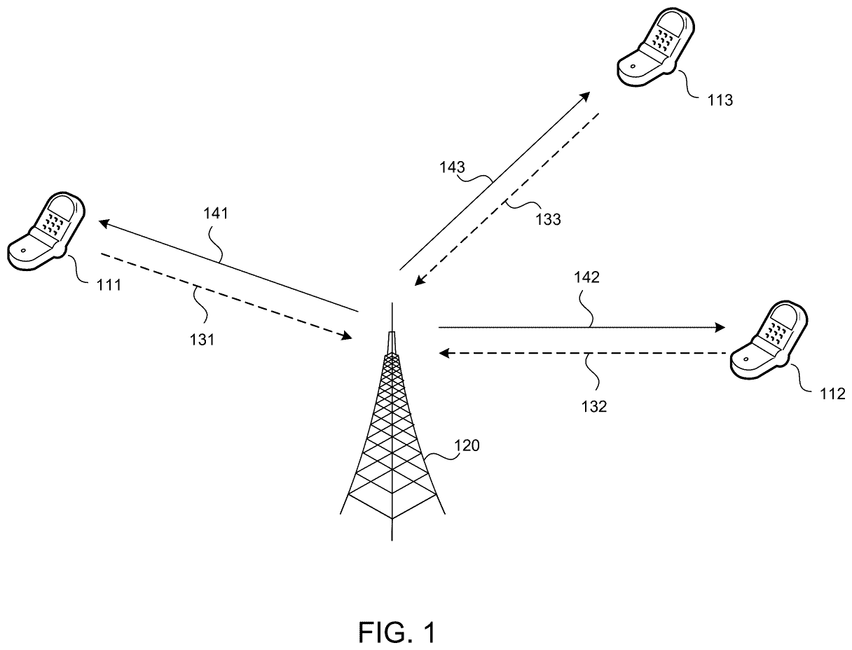

FIG. 1 shows an example of a wireless communication system (e.g., a long term evolution (LTE), 5G or NR cellular network) that includes a BS 120 and one or more user equipment (UE) 111, 112 and 113. In some embodiments, the uplink (UL) transmissions (131, 132, 133) can include uplink control information (UCI), higher layer signaling (e.g., UE assistance information or UE capability), or uplink information. In some embodiments, the downlink (DL) transmissions (141, 142, 143) can include Downlink Control Information (DCI) or high layer signaling or downlink information. The UE may be, for example, a smartphone, a tablet, a mobile computer, a machine to machine (M2M) device, a terminal, a mobile device, an Internet of Things (IoT) device, and so on.

The BS 120 can be configured with multiple transmission and reception points (TRPs). For example, the BS 120 can include multiple antenna arrays. A multi-TRP (also referred to as “mTRP”) approach can improve transmission throughput in LTE, long term evolution-advanced (LTE-A) and new radio access technologies (NR) in enhanced mobile broadband (eMBB) scenarios. In addition, the use of multi-TRP transmission or reception can reduce information blockage and improve the transmission reliability in ultra-reliability and low latency communication (URLLC) scenarios.

The BS 120 can also operate in high frequency bands, known as millimeter wave. The B.S. 120 can employ beamforming to direct signals and serve a greater number of UEs 111-113. The transmission energy of millimeter wave communication is mainly concentrated in the direct propagation path, which makes the communication link prone to attenuation or interruption in the case of beam blockage. Therefore, the design of a mechanism that can quickly recover from beam blockage and ensure the reliability and robustness of communication link has become an important research direction of high frequency transmission.

Although basic procedures for beam failure recovery exist, these processes are often inadequate for multi-TRP systems. This is due to lack of explicit association between DL channels, UL channels, reference signals (RS) used for beam failure detection and recovery, and particular TRPs. In addition, in single-DCI based (MTRP) scenarios, implicit determination of reference signals for detecting beam failure is not supported. Furthermore, for both single-DCI and multi-DCI based MTRP, the processes for updating the beam after the network receives beam failure recovery request are not well-defined. Thus, it is important to provide enhanced procedures for beam failure recovery following the beam failure recovery request. The technology disclosed in this document addresses these issues and others by describing fast and reliable beam failure recovery methods for M-TRP scenarios. In some embodiments, the beam failure recovery techniques comprise four processes: beam failure detection, new candidate beam identification, beam failure recovery request, and network response and UE behavior.

### Beam Failure Detection

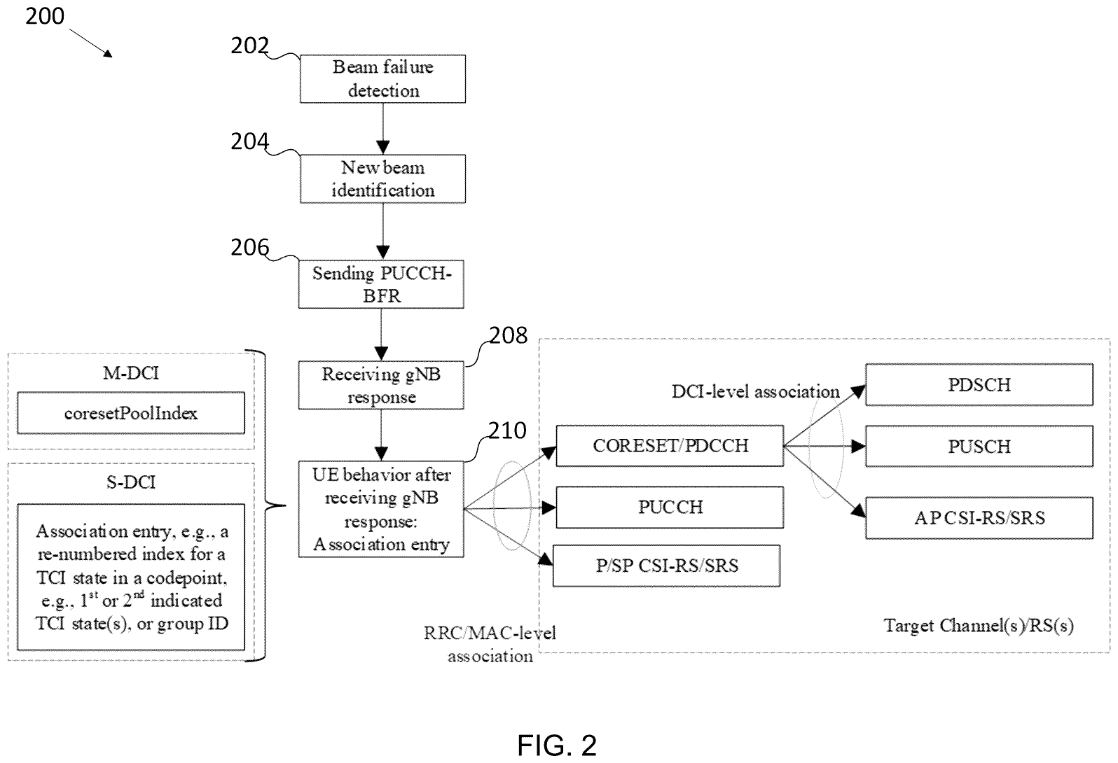

FIG. 2 illustrates an example process 200 for beam failure recovery, in accordance with embodiments of the present disclosure. At step 202, a UE (e.g., UE 111-113) performs beam failure detection by evaluating the quality of the downlink reference signals, referred in this document as beam failure detection reference signals (BFD-RS), which can be provided explicitly or implicitly. For an explicit configuration of BFD-RS resource sets, the UE is explicitly provided one or more RS resource sets for beam failure detection by radio resource control (RRC) or medium access control (MAC) control element (CE) signaling from the network. Each explicitly configured BFD-RS resource set can be associated with a TRP. For implicit configuration of BFD-RS resource sets, the RS resource sets for beam failure detection can be determined based on the activated Transmission Configuration Indicator (TCI) states of control resource sets (CORESETs) that correspond to the BFD-RS resource sets. More details are as follows.

### Explicit Configuration of BFD-RS Resource Sets

For each bandwidth part (BWP) of a serving cell, a UE can be explicitly provided multiple BFD-RS resource sets by the network. Two BFD-RS resource sets can be denoted as q_{0,0} and q_{0,1}, respectively. For example, the BFD-RS resource sets can be indicated by CSI-RS resource configuration indices or synchronization signals and physical broadcast channel (SS/PBCH) block indices for beam failure detection, which can be activated by a RRC or MAC CE signaling. Each BFD-RS resource set is associated with a TRP. The UE will judge whether the transmission quality of physical downlink control channels can meet the requirement by measuring these RS resource sets and declare beam failure for the corresponding TRP.

### Implicit Configuration of BFD-RS Resource Sets

If a UE is not explicitly provided q_{0,0} and q_{0,1} for each BWP of a serving cell, then the UE can implicitly determine which BFD-RS resource sets to use for detecting beam failure for different TRPs. For example, the BFD-RS sets can be determined based on the activated TCI states of corresponding CORESETs. For example, each CORESET can be associated with a particular parameter that indicates a correspondence between a BFD-RS resource set and a CORESET. The parameters used to indicate this correspondence are referred to in this document as “association entries.” For example, the parameter can include a RRC configurable ID that represents a TRP.

In some embodiments, the UE is provided two association entries or RRC configurable IDs corresponding to the first group of CORESETs and the second group of CORESETs that the UE uses for monitoring the physical downlink control channel (PDCCH), respectively. In some embodiments, the UE is provided no association entries or RRC configurable IDs corresponding to the first group of CORESETs and is provided an association entry or RRC configurable ID for the second group of CORESETs, respectively. Other codepoints may also be used. The first and second group of CORESETs are themselves associated with one or more TCI states. The TCI states can indicate RS indices of RS sets (e.g., CSI-RS). Thus, using these association entries, indices of the BFD-RS sets q_{0,0} and q_{0,1} (e.g., include CSI-RS resource configuration indices) can be mapped to values of RS indices in RS sets indicated by TCI states for the first group of CORESETs and the second group of CORESETs, respectively. For example, indices of the BFD-RS sets q_{0,0} and q_{0,1} (e.g., include CSI-RS resource configuration indices) can be the same values as the RS indices in RS sets indicated by TCI states for the first group of CORESETs and the second group of CORESETs, respectively.

In some embodiments, if there are two RS indices in a TCI state, the BFD-RS sets q_{0,0} and q_{0,1} include RS indices configured with QCL type-D indicated by the corresponding TCI states. In some embodiments, a CORESET that the UE uses for monitoring PDCCH is associated with two TCI states, referred to as the “first TCI state” and the “second TCI state”. The BFD-RS sets q_{0,0} and q_{0,1} can then include RS indices in the RS sets associated with a combination of the two TCI states. For example, at least the following five cases can be considered.

1. The first BFD-RS resource set q_{0,0} includes RS indices in an RS set associated with the first TCI state. The second BFD-RS resource set q_{0,1} includes RS indices in an RS set associated with the second TCI state.

2. The first BFD-RS resource set q_{0,0} includes RS indices in the RS set associated with the second TCI state. The second BFD-RS resource set q_{0,1} includes RS indices in the RS set associated with the first TCI state.

3. Each of the BFD-RS resource sets q_{0,0} and q_{0,1} includes RS indices in the RS sets associated with the two TCI states or the first TCI state of the two TCI states.

4. One of the BFD-RS resource sets q_{0,0} or q_{0,1} includes RS indices in the RS sets associated with the two TCI states. The other BFD-RS resource set q_{0,1} or q_{0,0} does not include any RS indices in the RS sets associated with the two TCI states.

5. None of the BFD-RS resource sets q_{0,0} and q_{0,1} includes RS indices in the RS sets associated with the two TCI states.

### Bfd-RS Resource Counter

In some embodiments, a maximum number of RS indices in a BFD-RS resource set q_{0,0} or q_{0,1} per BWP is set according to UE capability. Let this maximum number of RS indices be denoted as N. If the UE is not explicitly provided q_{0,0} or q_{0,1} and if the number of active TCI states for CORESETs associated with the same association entry is larger than N, or if the number of CORESETs associated with the same association entry is larger than N, or if the number of active TCI states for CORESETs associated with all association entries is larger than 2N, then the UE can determine the BFD-RS sets q_{0,0} or q_{0,1} according to an order based on monitoring periodicity. For example, indices of the BFD-RS sets can include CSI-RS resource configuration indices set to the same values as the RS indices in the RS sets associated with the active TCI states for PDCCH receptions in the first or second group of CORESETs corresponding to search space sets according to an ascending order of PDCCH monitoring periodicity, up to N indices.

In some embodiments, if more than one first or second group of CORESETs correspond to search space sets with the same monitoring periodicity, the UE determines the order of the first or second group CORESETs according to a descending order of a CORESET index.

### New Candidate Beam Identification

The UE can be provided RS resource sets to find new candidate beams for reporting at 204, referred in this document as new beam identification reference signals (NBI-RS). The NBI-RS sets are associated with different candidate beams. For each BWP of a serving cell, the UE can be provided two NBI-RS resource sets q_{1,0} and q_{1,1}, with CSI-RS resource configuration indices and/or SS/PBCH block indices, for radio link quality measurements on the BWP of the serving cell. In some embodiments, the NBI-RS resource sets and BFD-RS resource sets are one-to-one associated. For example the NBI-RS set q_{1,0} is associated with the BFD-RS set q_{0,0}, and the NBI-RS set q_{1,1} is associated with the BFD-RS set q_{0,1}. This association can be denoted for multiple resource sets by the second index, b, for resource sets labeled with the form q_{a,b}. The association between the NBI-RS resource sets q_{1,0} or q_{1,1} and BFD-RS resource sets q_{0,0} and q_{0,1} enable the NBI-RS resource sets to also be associated with particular TRPs (e.g., a first or second TRP). By measuring these NBI-RS resource sets, the UE determines a new candidate beam for beam failure recovery whose measured Layer 1 Reference Signal Received Power (L1-RSRP) is greater than or equal to a pre-defined threshold.

### Beam Failure Recovery Request

If the quality of a BFD-RS resource is lower than a pre-defined threshold, the UE provides a beam failure instance (BFI) indication to MAC. If the number of BFI indications from the physical layer in a period of time reaches the maximum value configured by the network, then the UE declares a beam failure. In addition, the UE initiates the beam failure recovery process at 206 to indicate the beam failure and indicate a new candidate beam to the network.

The UE can be provided a first and/or second configuration for physical uplink control channel (PUCCH) transmissions with a link recovery request (LRR). The PUCCH resource or configuration is associated with the BFD-RS resource set q_{0,0} or q_{0,1}. This enables the UE to inform the network of which TRP a beam failure is associated with. For example, if the UE is provided only the first configuration, the UE transmits a PUCCH with a LRR for either the failed BFD-RS resource set q_{0,0} or q_{0,1}. If the UE is provided both the first and second configurations, the UE uses the first configuration to transmit a PUCCH with LRR associated with the failed BFD-RS resource set q_{0,0} and the second configuration to transmit a PUCCH with LRR associated with the failed BFD-RS resource set q_{0,1}. In this manner, the network can be informed which TRP a beam failure occurs on, because each BFD-RS resource set q_{0,0} or q_{0,1} can be associated with a different TRP, as described above.

In some embodiments, in addition to declaring a beam failure by transmitting the corresponding PUCCH associated with the failed BFD-RS resource set, the UE provides an index of a failed BFD-RS resource set (e.g., as an indication of failed TRP link). The UE can also provide an indication of whether a new candidate beam is identified in the NBI-RS resource set associated with the failed BFD-RS resource set, or an indicator q_{new} representing the new candidate beam in the corresponding NBI-RS resource set (if identified) in a first physical uplink shared channel (PUSCH) transmission. In some embodiments, upon request from higher layers, the UE indicates to higher layers whether there is at least one periodic CSI-RS configuration index or SS/PBCH block index from the NBI-RS resource set q_{1,0} or q_{1,1} with corresponding measurements (e.g., L1-RSRP) that are greater than or equal to the pre-defined threshold. The UE also provides the periodic CSI-RS configuration indices and/or SS/PBCH block indices of q_{new} from the NBI-RS set q_{1,0} or q_{1,1}, if identified, along with the corresponding L1-RSRP measurements that are greater than or equal to the pre-defined threshold.

### NW Response and UE Behavior

After receiving a beam failure indication and new candidate beam information reported by UE, the network can provide a beam failure recovery response at 208 and use the new candidate beam to transmit corresponding downlink control signaling. If the network's response is received during a monitoring window, the UE can consider the beam failure recovery procedure to be successful.

At 210, the UE performs actions after receiving the network response. In some embodiments, the UE continues to monitor PDCCH and physical downlink shared channel (PDSCH) using QCL assumptions of the new candidate beam until a new TCI state for PDCCH is indicated. More details are provided as follows.

The beam failure recovery response from the network can be a DCI with a toggled new data indicator (NDI) value scheduling a same hybrid automatic repeat request (HARQ) process ID as the PUSCH carrying the beam failure recovery request described previously. After a number of symbols (e.g., 28 symbols) from the time the UE receives the beam failure recovery response from the network, the UE assumes the same QCL parameters as the ones associated with the new candidate beam q_{new}, which is associated with the failed BFD-RS resource set as described previously. The QCL parameters can be assumed for all PDSCH or PDCCH receptions, as well as other signals or channels that share the same indicated TCI state as the PDSCH or PDCCH reception. In some embodiments, after a number of symbols from the time the UE receives the beam failure recovery response from the network, the UE can perform at least one of the following:
1. The UE monitors PDCCH in the first group of CORESETs, receives PDSCH scheduled by the PDCCH in the first group of CORESETs, or receives an aperiodic CSI-RS resource in a CSI-RS resource set with the same indicated TCI state as for the PDCCH and PDSCH, using the same antenna port QCL parameters that are associated with the corresponding index q_{new} from NBI-RS set q_{1,0}. The first group of CORESETs can be associated with no association entry or be associated with the same association entry
2. The UE monitors PDCCH in the second group of CORESETs, receives PDSCH scheduled by PDCCH on the second group of CORESETs, or receives an aperiodic CSI-RS resource in a CSI-RS resource set with the same indicated TCI state as for the PDCCH and PDSCH, using the same antenna port QCL parameters that are one associated with the corresponding index q_{new} from NBI-RS set q_{1,1}. The second group of CORESETs can be associated with the same association entry.

After a number of symbols (e.g., 28 symbols) from the time the UE receives the beam failure recovery response from the network, the UE can assume the same UL spatial filter that is associated with the new candidate beam q_{new} associated with the failed BFD-RS resource set. The UL spatial filter can be used for PUSCH transmissions and PUCCH resources, as well as other signals or channels that share the same indicated TCI state as the PUSCH and PUCCH resources. In some embodiments, after a number of symbols from the time the UE receives the beam failure recovery response from the network, the UE can perform at least one of the following:
1. The UE transmits a PUCCH in the first PUCCH resource group, a PUSCH associated with a first sounding reference signal (SRS) resource (or resource set) group, or an SRS with a same indicated TCI state used for the PUCCH and PUSCH, using the spatial domain filter that is associated with the corresponding index q_{new} from the NBI-RS set q_{1,0}. The first PUCCH resource group and the first SRS resource (or resource set) group can be associated with no association entry or with the same association entry.

In some embodiments, the UE uses the following parameters to determine a corresponding power: the values of target received power p0, fractional path-loss compensation factor alpha, or the PUSCH, PUCCH, or SRS power control adjustment states are associated with the smallest or second smallest value among UL power control indices configured by network.
2. The UE transmits a PUCCH in the second PUCCH resource group, a PUSCH associated with a second SRS resource (or resource set) group, or an SRS with a same indicated TCI state used for the PUCCH and PUSCH, using the spatial domain filter that is associated with the corresponding index q_{new} from the NBI-RS set q_{1,1}. The second PUCCH resource group and the second SRS resource (or resource set) group can be associated with the same association entry.

In some embodiments, the UE uses the following parameters to determine a corresponding power: the values of target received power p0, fractional path-loss compensation factor alpha, or the PUSCH, PUCCH, or SRS power control adjustment states are associated with the smallest or second smallest value among UL power control indices configured by the network.

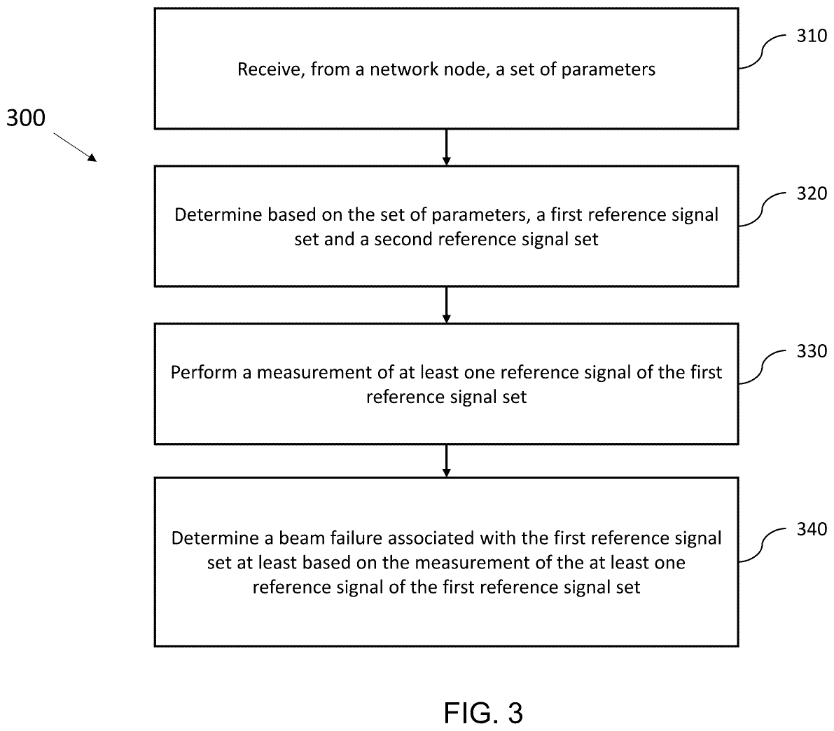

FIG. 3 is a flow diagram illustrating an example process 300 for wireless communication, in accordance with embodiments of the present disclosure. For example, the process 300 can be performed by a wireless device (e.g., wireless device 111-113 of FIG. 1).

At step 310, a set of parameters is received from a network node. For example, the network node can be configured with multiple TRPs. In some embodiments, the set of parameters can include one or more “association entries” as described above. For example, the set of parameters can enable the wireless device to implicitly determine reference signal sets for beam failure detection.

At step 320, a first reference signal set and a second reference signal set are determined based on the set of parameters. For example, the set of parameters can indicate a first correspondence between the first RS set and a first control resource set (CORESET) and a second correspondence between the second RS set and a second CORESET. In some embodiments, the first CORESET is associated with a first transmission configuration indicator (TCI) state, the first TCI state indicating a reference signal with a reference signal index that corresponds to an index of the at least one RS of the first RS set.

At step 330, a measurement of at least one reference signal of the first reference signal set is performed. At step 340, a beam failure associated with the first reference signal set is determined based on the measurement of the at least one reference signal from step 330.

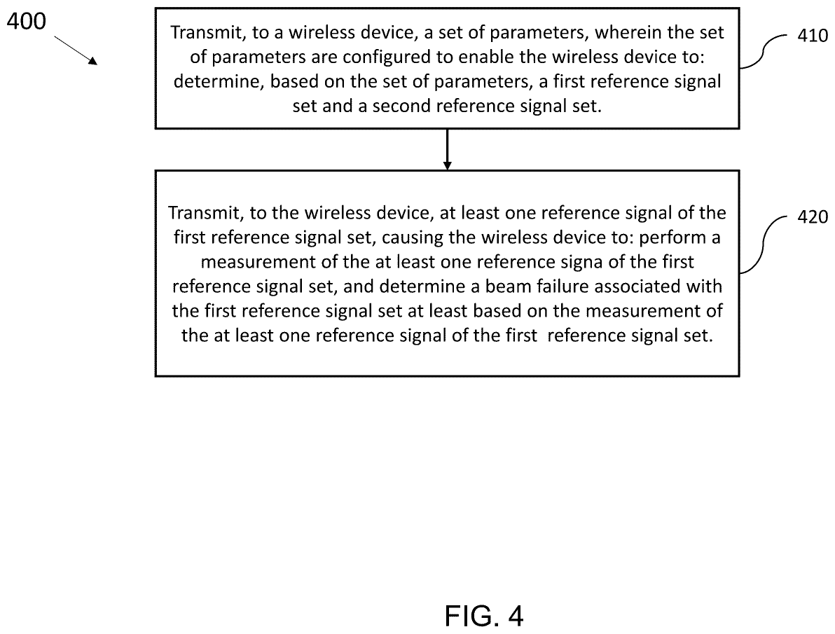

FIG. 4 is a flow diagram illustrating an example process 400 for wireless communication, in accordance with embodiments of the present disclosure. For example, the process 400 can be performed by a network node configured with multiple TRPs (e.g., base station 120 of FIG. 1).

At step 410, a set of parameters is transmitted to a wireless device. The set of parameters are configured to enable the wireless device to determine, based on the set of parameters, a first reference signal set and a second reference signal set. In some embodiments, the set of parameters can include one or more “association entries” as described above. For example, the set of parameters can enable the wireless device to implicitly determine reference signals for beam failure detection.

In some embodiments, the set of parameters indicates a first correspondence between the first RS set and a first CORESET and a second correspondence between the second RS set and a second CORESET. In some embodiments, the first CORESET is associated with a first transmission configuration indicator (TCI) state, the first TCI state indicating a reference signal with a reference signal index that corresponds to an index of the at least one RS of the first RS set.

At step 420, at least one reference signal of the first reference signal set is transmitted to the wireless device. This transmission causes the wireless device to perform a measurement of the at least one reference signal of the first reference signal set and determine a beam failure associated with the first reference signal set based on the measurement of the at least one reference signal.

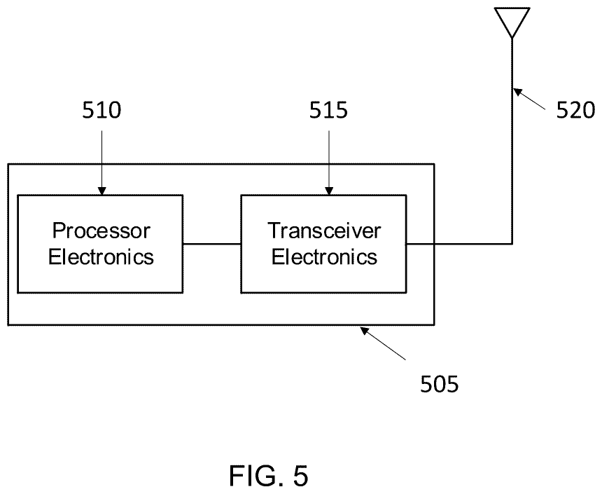

FIG. 5 is a block diagram representation of a portion of an apparatus based on some embodiments of the disclosed technology. An apparatus 505 such as a network device or a base station or a wireless device (or UE), can include processor electronics 510 such as a microprocessor that implements one or more of the techniques presented in this document. The apparatus 505 can include transceiver electronics 515 to send and/or receive wireless signals over one or more communication interfaces such as antenna(s) 520. The apparatus 505 can include other communication interfaces for transmitting and receiving data. Apparatus 505 can include one or more memories (not explicitly shown) configured to store information such as data and/or instructions. In some implementations, the processor electronics 510 can include at least a portion of the transceiver electronics 515. In some embodiments, at least some of the disclosed techniques, modules or functions are implemented using the apparatus 505.

It will be appreciated that the present document discloses techniques that can be embodied into wireless communication systems to provide bandwidth part specific configurations in order to reduce signaling overhead in a primary cell while supporting fast activation of the secondary cell(s).

### Solution Clauses

Some embodiments may preferably incorporate the following solutions as described herein.

For example, the clauses listed below may be used by wireless device implementations (e.g., UE 111-113 of FIG. 1) for performing beam failure recovery as described herein.

Clause 1. A method (e.g., method 300 of FIG. 3) of wireless communication comprising: receiving, by a wireless device from a network node, a set of parameters; determining, by the wireless device based on the set of parameters, a first reference signal (RS) set and a second RS set; performing, by the wireless device, a measurement of at least one RS of the first RS set; and determining, by the wireless device, a beam failure associated with the first RS set at least based on the measurement of the at least one RS of the first RS set.

Clause 2. The method of clause 1, wherein the set of parameters indicates a first correspondence between the first RS set and a first control resource set (CORESET) and a second correspondence between the second RS set and a second CORESET.

Clause 3. The method of clause 2, wherein the first CORESET is associated with a first transmission configuration indicator (TCI) state, the first TCI state indicating a reference signal with a reference signal index that corresponds to an index of the at least one RS of the first RS set.

Clause 4. The method of clause 3, wherein the reference signal indicated by the first TCI state is a channel state information (CSI) reference signal.

Clause 5. The method of any of the preceding clauses, wherein a CORESET is associated with a first TCI state and a second TCI state, the first TCI state indicating a first reference signal with a first reference signal index, the second TCI state indicating a second reference signal with a second reference signal index.

Clause 6. The method of any of the preceding clauses, wherein a first RS set includes a first index corresponding with at least one of the following: a first reference signal index, a second reference signal index, both the first reference signal index and the second reference signal index, or none of the first and second reference signal indices.

Clause 7. The method of any of the preceding clauses, wherein the second RS set includes a second index corresponding with at least one of the following: a first reference signal index, a second reference signal index, both the first reference signal index and the second reference signal index, or none of the first and second reference signal indices.

Clause 8. The method of any of the preceding clauses, wherein a first correspondence is indicated by a first parameter of the set of parameters, and wherein a second correspondence is indicated by a second parameter of the set of parameters.

Clause 9. The method of any of the preceding clauses, wherein a first correspondence is indicated by an absence of a parameter of the set of parameters, and wherein a second correspondence is indicated by the parameter.

Clause 10. The method of any of the preceding clauses, wherein N represents a maximum number of RS indices included in the first RS set, N being an integer, and wherein RS indices of the first RS set are determined in an order based on monitoring periodicity when at least one of the following is satisfied: a number of TCI states associated with CORESETs indicated by a parameter of the set of parameters is greater than N; a number of CORESETS indicated by the parameter is greater than N; a number of TCI states associated with CORESETs indicated by the set of parameters is greater than 2N; or a number of CORESETs indicated by the set of parameters is greater than 2N.

Clause 11. The method of any of the preceding clauses, further comprising: determining, by the wireless device, a third RS set and a fourth RS set, wherein the first RS set is associated with the third RS set, and wherein the second RS set is associated with the fourth RS set; and identifying, by the wireless device, a new candidate RS based on at least one RS of the third or fourth RS set.

Clause 12. The method of any of the preceding clauses, further comprising: in response to determining the beam failure, transmitting, to the network node, a beam failure recovery request, wherein the beam failure recovery request includes at least one of: an index associated with the first RS set, an indication of whether a new candidate RS is identified based on a third RS set corresponding to the first RS set, or an index of the new candidate RS representing a new candidate beam.

Clause 13. The method of any of the preceding clauses, further comprising: transmitting, to the network node, a beam failure recovery request indicating a first candidate RS from a third RS set; and receiving, from the network node, a beam failure recovery response; and receiving, from the network node, a transmission, wherein the transmission is received using a quasi-colocation (QCL) parameter associated with the first candidate RS.

Clause 14. The method of any of the preceding clauses, wherein the set of parameters maps the first RS set to a first CORESET, and wherein the transmission is a physical downlink control channel (PDCCH) transmission in the first CORESET, a physical downlink shared channel (PDSCH) transmission scheduled by a PDCCH carried by the first CORESET, or a channel state information (CSI) reference signal resource transmission with a TCI state associated with the PDCCH or PDSCH.

Clause 15. The method of any of the preceding clauses, further comprising: transmitting, to the network node, a first uplink transmission including at least one of: a physical uplink control channel (PUCCH) transmission associated with a PUCCH resource group, a physical uplink shared channel (PUSCH) transmission associated with a sounding reference signal (SRS) resource group, or an SRS transmission with a TCI state associated with the PUCCH transmission or the PUSCH transmission.

Clause 16. The method of clause 15, wherein the first uplink transmission is performed using a first spatial filter associated with the first candidate RS.

Clause 17. The method of clause 15 or 16 wherein the PUCCH resource group and the SRS resource group are associated with a same parameter of the set of parameters.

Clause 18. The method of any of the preceding clauses, further comprising: receiving, from the network node, a plurality of power control parameters associated with a power control index, wherein a power control parameter of the plurality of power control parameters associated with the first uplink transmission is determined based on being associated with a smallest or second smallest power control index.

Clause 19. The method of any of the preceding clauses, further comprising: performing, by the wireless device, a measurement of at least one RS of the second RS set; and determining, by the wireless device, a beam failure associated with the second RS set based on the measurement of the at least one RS of the second RS set.

Clause 20. The method any of clauses 13-19, wherein the beam failure recovery request indicates a second candidate RS from a fourth RS set, the method further comprising: receiving, from the network node, a second transmission, wherein the second transmission is received using a second quasi-colocation (QCL) parameter associated with the second candidate RS.

Clause 21. The method of any of the preceding clauses, further comprising: transmitting, to the network node, a second uplink transmission using a second spatial filter associated with a second candidate RS, wherein the second candidate RS is from a fourth RS set.

Clause 22. The method of clause 21, wherein a power control parameter associated with the second uplink transmission is determined based on the power control parameter having a second smallest index among a plurality of power control parameters.

For example, the solutions listed below may be used by network implementations (e.g., BS 120 of FIG. 1) for performing beam failure recovery as described herein.

Clause 23. A method (e.g., method 400 of FIG. 4) of wireless communication comprising: transmitting, to a wireless device from a network node, a set of parameters, wherein the set of parameters are configured to enable the wireless device to: determine, based on the set of parameters, a first reference signal (RS) set and a second RS set; and transmit, to the wireless device, at least one RS of the first RS set, causing the wireless device to: perform a measurement of at the least one RS of the first RS set; and determine a beam failure associated with the first RS set at least based on the measurement of the at least one RS of the first RS set.

Clause 24. The method of clause 23, wherein the set of parameters indicates a first correspondence between the first RS set and a first control resource set (CORESET) and a second correspondence between the second RS set and a second CORESET.

Clause 25. The method of clause 24, wherein the first CORESET is associated with a first transmission configuration indicator (TCI) state, the first TCI state indicating a reference signal with a reference signal index that corresponds to an index of the at least one RS of the first RS set.

Clause 26. The method of clause 25, wherein the reference signal indicated by the first TCI state is a channel state information (CSI) reference signal.

Clause 27. The method of any of clauses 23-26, wherein a CORESET is associated with a first TCI state and a second TCI state, the first TCI state indicating a first reference signal with a first reference signal index, the second TCI state indicating a second reference signal with a second reference signal index.

Clause 28. The method of 27, wherein the first RS set includes a first index corresponding with at least one of the following: the first reference signal index, the second reference signal index, both the first reference signal index and the second reference signal index, or none of the first and second reference signal indices.

Clause 29. The method of any of clauses 23-28, wherein the second RS set includes a second index corresponding with at least one of the following: the first reference signal index, the second reference signal index, both the first reference signal index and the second reference signal index, or none of the first and second reference signal indices.

Clause 30. The method of any of clauses 23-29, wherein a first correspondence is indicated by a first parameter of the set of parameters, and wherein a second correspondence is indicated by a second parameter of the set of parameters.

Clause 31. The method of any of clauses 23-30, wherein the first correspondence is indicated by an absence of a parameter of the set of parameters, and wherein the second correspondence is indicated by the parameter.

Clause 32. The method of any of clauses 23-31, wherein N represents a maximum number of RS indices included in the first RS set, N being an integer, and wherein RS indices of the first RS set are determined in an order based on monitoring periodicity when at least one of the following is satisfied: a number of TCI states associated with CORESETs indicated by a parameter of the set of parameters is greater than N; a number of CORESETS indicated by the parameter is greater than N; a number of TCI states associated with CORESETs indicated by the set of parameters is greater than 2N; or a number of CORESETs indicated by the set of parameters is greater than 2N.

Clause 33. The method of any of clauses 23-32, wherein the wireless device is configured to determine a third RS set and a fourth RS set, wherein the first RS set is associated with the third RS set, and wherein the second RS set is associated with the fourth RS set; and identify a new candidate RS based on at least one RS of the third or fourth RS set.

Clause 34. The method of any of clauses 23-33, further comprising: receiving, from the wireless device, a beam failure recovery request, wherein the beam failure recovery request includes at least one of: an index associated with the first RS set, an indication of whether a new candidate RS is identified based on a third RS set corresponding to the first RS set, or an index of the new candidate RS representing a new candidate beam.

Clause 35. The method of any of clauses 23-34, further comprising: receiving, from the wireless device, a beam failure recovery request indicating a first candidate RS from a third RS set; and transmitting, to the wireless device, a beam failure recovery response; and transmitting, to the wireless device, a transmission, wherein the transmission is received using a quasi-colocation (QCL) parameter associated with the first candidate RS.

Clause 36. The method of any of clauses 23-35, wherein the set of parameters maps the first RS set to a first CORESET, and wherein the transmission is a physical downlink control channel (PDCCH) transmission in the first CORESET, a physical downlink shared channel (PDSCH) transmission scheduled by a PDCCH carried by the first CORESET, or a channel state information (CSI) reference signal resource transmission with a TCI state associated with the PDCCH or PDSCH.

Clause 37. The method of any of clauses 23-36, further comprising: receiving, from the wireless device, a first uplink transmission including at least one of: a physical uplink control channel (PUCCH) transmission associated with a PUCCH resource group, a physical uplink shared channel (PUSCH) transmission associated with a sounding reference signal (SRS) resource group, or an SRS transmission with a TCI state associated with the PUCCH transmission or the PUSCH transmission.

Clause 38. The method of clause 37, wherein the first uplink transmission is received using a first spatial filter associated with the first candidate RS.

Clause 39. The method of clause 37 or 38, wherein the PUCCH resource group and the SRS resource group are associated with a same parameter of the set of parameters.

Clause 40. The method of any of clauses 23-39, further comprising: transmitting, to the wireless device, a plurality of power control parameters associated with a power control index, wherein a power control parameter of the plurality of power control parameters associated with the first uplink transmission is determined based on being associated with a smallest or second smallest power control index.

Clause 41. The method of any of clauses 23-40, further comprising: transmitting, to the wireless device, at least one RS of the second RS set, wherein the at least one RS enables the wireless device to determine a beam failure associated with the second RS set based on a measurement of the at least one RS of the second RS set.

Clause 42. The method of any clauses 35-41, wherein the beam failure recovery request indicates a second candidate RS from a fourth RS set, the method further comprising: transmitting, to the wireless device, a second transmission, wherein the second transmission is received using a second quasi-colocation (QCL) parameter associated with the second candidate RS.

Clause 43. The method of any of clauses 23-42, further comprising: receiving, from the wireless device, a second uplink transmission using a second spatial filter associated with a second candidate RS, wherein the second candidate RS is from a fourth RS set.

Clause 44. The method of clause 43, wherein a power control parameter associated with the second uplink transmission is determined based on the power control parameter having a second smallest index among a plurality of power control parameters.

For example, the solutions listed below may be used by an apparatus (e.g., apparatus 500 of FIG. 5) or by a computer-readable medium for performing beam failure recovery as described herein.

Clause 45. An apparatus for wireless communication comprising a processor configured to implement the method of any of clauses 1 to 44.

Clause 46. A computer readable medium having code stored thereon, the code when executed by a processor of a computing system, causing the computing system to implement a method recited in any of clauses 1 to 44.

Some of the embodiments described herein are described in the general context of methods or processes, which may be implemented in one embodiment by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Therefore, the computer-readable media can include a non-transitory storage media. Generally, program modules may include routines, programs, objects, components, data structures, etc. that perform particular tasks or implement particular abstract data types. Computer- or processor-executable instructions, associated data structures, and program modules represent examples of program code for executing steps of the methods disclosed herein. The particular sequence of such executable instructions or associated data structures represents examples of corresponding acts for implementing the functions described in such steps or processes.

Some of the disclosed embodiments can be implemented as devices or modules using hardware circuits, software, or combinations thereof. For example, a hardware circuit implementation can include discrete analog and/or digital components that are, for example, integrated as part of a printed circuit board. Alternatively, or additionally, the disclosed components or modules can be implemented as an Application Specific Integrated Circuit (ASIC) and/or as a Field Programmable Gate Array (FPGA) device. Some implementations may additionally or alternatively include a digital signal processor (DSP) that is a specialized microprocessor with an architecture optimized for the operational needs of digital signal processing associated with the disclosed functionalities of this application. Similarly, the various components or sub-components within each module may be implemented in software, hardware or firmware. The connectivity between the modules and/or components within the modules may be provided using any one of the connectivity methods and media that is known in the art, including, but not limited to, communications over the Internet, wired, or wireless networks using the appropriate protocols.

While this document contains many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Only a few implementations and examples are described, and other implementations, enhancements, and variations can be made based on what is described and illustrated in this disclosure.

What is claimed is:

1. A method of wireless communication comprising:
receiving, by a wireless device from a network node, a set of parameters;
determining, by the wireless device based on the set of parameters, a first reference signal (RS) set and a second RS set;
performing, by the wireless device, a measurement of at least one RS of the first RS set; and
determining, by the wireless device, a beam failure associated with the first RS set at least based on the measurement of the at least one RS of the first RS set,
wherein N represents a maximum number of RS indices included in the first RS set, N being an integer, and wherein RS indices of the first RS set are determined in an order based on monitoring periodicity when at least one of the following is satisfied:
a number of transmission configuration indicator (TCI) states associated with control resource sets (CORESETs) indicated by a parameter of the set of parameters is greater than N;
a number of CORESETs indicated by the parameter is greater than N;
a number of TCI states associated with CORESETs indicated by the set of parameters is greater than 2N; or
a number of CORESETs indicated by the set of parameters is greater than 2N.

2. The method of claim 1, wherein the set of parameters indicates a first correspondence between the first RS set and a first control resource set (CORESET) and a second correspondence between the second RS set and a second CORESET.

3. The method of claim 2, wherein the first CORESET is associated with a first transmission configuration indicator (TCI) state, the first TCI state indicating a reference signal with a reference signal index that corresponds to an index of the at least one RS of the first RS set, and wherein the reference signal indicated by the first TCI state is a channel state information (CSI) reference signal.

4. The method of claim 2, wherein the first correspondence is indicated by a first parameter of the set of parameters and the second correspondence is indicated by a second parameter of the set of parameters; or
wherein the first correspondence is indicated by an absence of a parameter of the set of parameters and the second correspondence is indicated by the parameter.

5. The method of claim 1, further comprising:
determining, by the wireless device, a third RS set and a fourth RS set,
wherein the first RS set is associated with the third RS set, and
wherein the second RS set is associated with the fourth RS set; and
identifying, by the wireless device, a new candidate RS based on at least one RS of the third or fourth RS set.

6. The method of claim 1, further comprising:
in response to determining the beam failure, transmitting, to the network node, a beam failure recovery request,
wherein the beam failure recovery request includes at least one of: an index associated with the first RS set, an indication of whether a new candidate RS is identified based on a third RS set corresponding to the first RS set, or an index of the new candidate RS representing a new candidate beam.

7. The method of claim 1, further comprising:
transmitting, to the network node, a beam failure recovery request indicating a first candidate RS from a third RS set; and
receiving, from the network node, a transmission,
wherein the transmission is received using a quasi-colocation (QCL) parameter associated with the first candidate RS.

8. The method of claim 7, wherein the set of parameters maps the first RS set to a first CORESET, and wherein the transmission is a physical downlink control channel (PDCCH) transmission in the first CORESET, a physical downlink shared channel (PDSCH) transmission scheduled by a PDCCH carried by the first CORESET, or a channel state information (CSI) reference signal resource transmission with a TCI state associated with the PDCCH or PDSCH.

9. The method of claim 7, further comprising:
transmitting, to the network node, a first uplink transmission including at least one of: a physical uplink control channel (PUCCH) transmission associated with a PUCCH resource group, a physical uplink shared channel (PUSCH) transmission associated with a sounding reference signal (SRS) resource group, or an SRS transmission with a TCI state associated with the PUCCH transmission or the PUSCH transmission,
wherein the first uplink transmission is performed using a first spatial filter associated with the first candidate RS, or wherein the PUCCH resource group and the SRS resource group are associated with a same parameter of the set of parameters.

10. The method of claim 9, further comprising:
receiving, from the network node, a plurality of power control parameters associated with a power control index,
wherein a power control parameter of the plurality of power control parameters associated with the first uplink transmission is determined based on being associated with a smallest or second smallest power control index.

11. The method of claim 1, further comprising:
performing, by the wireless device, a measurement of at least one RS of the second RS set; and
determining, by the wireless device, a beam failure associated with the second RS set based on the measurement of the at least one RS of the second RS set.

12. The method of claim 7, wherein the beam failure recovery request indicates a second candidate RS from a fourth RS set, the method further comprising:
receiving, from the network node, a second transmission,
wherein the second transmission is received using a second quasi-colocation (QCL) parameter associated with the second candidate RS.

13. The method of claim 1, further comprising:
transmitting, to the network node, a second uplink transmission using a second spatial filter associated with a second candidate RS,
wherein the second candidate RS is from a fourth RS set, or
wherein a power control parameter associated with the second uplink transmission is determined based on the power control parameter having a second smallest index among a plurality of power control parameters.

14. A method of wireless communication comprising:
transmitting, to a wireless device from a network node, a set of parameters,
wherein the set of parameters are configured to enable the wireless device to:
determine, based on the set of parameters, a first reference signal (RS) set and a second RS set; and
transmitting, to the wireless device, at least one RS of the first RS set, causing the wireless device to:
perform a measurement of the at least one RS of the first RS set, and
determine a beam failure associated with the first RS set at least based on the measurement of the at least one RS of the first RS set,
wherein N represents a maximum number of RS indices included in the first RS set, N being an integer, and wherein RS indices of the first RS set are determined in an order based on monitoring periodicity when at least one of the following is satisfied:
a number of transmission configuration indicator (TCI) states associated with control resource sets (CORESETs) indicated by a parameter of the set of parameters is greater than N;
a number of CORESETs indicated by the parameter is greater than N;
a number of TCI states associated with CORESETs indicated by the set of parameters is greater than 2N; or
a number of CORESETs indicated by the set of parameters is greater than 2N.

15. A wireless communication apparatus comprising at least one processor and a memory storing instructions, execution of which by the at least one processor causes the apparatus to perform operations comprising:
receiving, from a network node, a set of parameters;
determining, based on the set of parameters, a first reference signal (RS) set and a second RS set;
performing a measurement of at least one RS of the first RS set; and
determining a beam failure associated with the first RS set at least based on the measurement of the at least one RS of the first RS set,
wherein N represents a maximum number of RS indices included in the first RS set, N being an integer, and wherein RS indices of the first RS set are determined in an order based on monitoring periodicity when at least one of the following is satisfied:
a number of transmission configuration indicator (TCI) states associated with control resource sets (CORESETs) indicated by a parameter of the set of parameters is greater than N;
a number of CORESETs indicated by the parameter is greater than N;
a number of TCI states associated with CORESETs indicated by the set of parameters is greater than 2N; or
a number of CORESETs indicated by the set of parameters is greater than 2N.

16. The apparatus of claim 15, wherein the set of parameters indicates a first correspondence between the first RS set and a first control resource set (CORESET) and a second correspondence between the second RS set and a second CORESET.

17. The apparatus of claim 16, wherein the first CORESET is associated with a first transmission configuration indicator (TCI) state, the first TCI state indicating a reference signal with a reference signal index that corresponds to an index of the at least one RS of the first RS set, and wherein the reference signal indicated by the first TCI state is a channel state information (CSI) reference signal.

18. The apparatus of claim 16, wherein the first correspondence is indicated by a first parameter of the set of parameters and the second correspondence is indicated by a second parameter of the set of parameters; or
wherein the first correspondence is indicated by an absence of a parameter of the set of parameters and the second correspondence is indicated by the parameter.

19. The apparatus of claim 15, wherein the operations further comprise:
determining a third RS set and a fourth RS set,
wherein the first RS set is associated with the third RS set, and
wherein the second RS set is associated with the fourth RS set; and
identifying a new candidate RS based on at least one RS of the third or fourth RS set.

20. The apparatus of claim 15, wherein the operations further comprise:
in response to determining the beam failure, transmitting, to the network node, a beam failure recovery request,
wherein the beam failure recovery request includes at least one of: an index associated with the first RS set, an indication of whether a new candidate RS is identified based on a third RS set corresponding to the first RS set, or an index of the new candidate RS representing a new candidate beam.
